(19) United States
(12) Patent Application Publication
(10) Pub. No.: US 2010/0237239 A1
(43) Pub. Date: Sep. 23, 2010

(54) Ion Beam Detector

(75) Inventors: Akira Noda, Uji-shi Kyoto (JP); Yoshihisa Iwashita, Uji-shi Kyoto (JP); Shu Nakamura, Kyoto-shi Kyoto (JP); Hiroyuki Daido, Kizugawa-shi Kyoto (JP); Satoru Yamada, Chiba (JP)

Correspondence Address: BIRCH STEWART KOLASCH & BIRCH, PO BOX 747, FALLS CHURCH, VA, 22040-0747, US

(73) Assignees: KYOTO UNIVERSITY, Kyoto (JP); NATIONAL INSTITUTE OF RADIOLOGICAL SCIENCES, Chiba-shi, Chiba (JP)

(21) Appl. No.: 12/223,982

(22) PCT Filed: Feb. 14, 2007
(86) PCT No.: PCT/JP2007/052645

§ 371 Date: Jun. 8, 2010

(30) Foreign Application Priority Data
Feb. 15, 2006 (JP) 2006-038533

(51) Int. Cl. H01J 49/40

(52) U.S. Cl. 250/287

(57) ABSTRACT

In order to attain an object to realize an ion beam capable of (i) immediately determining energy of the ion beam to be generated, and (ii) measuring an ion beam in real time while carrying out laser irradiation, an ion beam detector (1) of the present invention includes a light conversion section (7) transmitting X-rays mixed in with ions (3) and converting the ions (3) to light; a light detection section (9) detecting, as an electric signal, the light converted from the ions (3) by the light converting section (7); a time-of-flight measurement section (10) measuring a time of flight for the ions (3) to reach the light conversion section (7); an electron removal section (5) removing electrons mixed in with the ions (3) and a light shielding section (6) shielding light mixed in with the ions (3), each of which is provided in an upstream of the light conversion section from which the ion beam comes to the light conversion section; and a curved section (8) between the light conversion section (7) and the light detection section (9), curved with respect to an optical axis of the ions (3) incident on the light conversion section (7).

### TECHNICAL FIELD

The present invention relates to an ion beam detector.

### BACKGROUND ART

Conventionally, solid state track detectors such as CR39 and the like have mainly been used to measure an ion beam generated when high intensity laser is irradiated to a material. In an experimental environment of irradiating high intensity laser to a material, light, X-rays, and electrons are mixed in with the ion beam. Therefore, it is not possible to sufficiently measure an S/N ratio of an ion signal to be detected, if the ion beam is measured by an online detector used in nuclear tests and the like, such as SSD and MCP.

On the other hand, the solid state track detector CR39 does not sense the light, X-rays, or electrons other than the ion beam. Therefore, the CR39 is recognized as the most appropriate device to measure the ion beam generated when high intensity laser is irradiated to a material.

The following description describes a detection theory of the solid state track detector CR39.

Specifically, when an ion beam is incident on the CR39, damage is generated on the CR39 in spots along a track of the ion beam. The CR39 which has the damage generated thereon is taken out from a vacuum chamber, and is chemically processed (etched) with a base such as NaOH. An etching speed along the track of the ion beam is faster compared to the etching speed of a spot where there is no damage. Therefore, a scar (etch pit) is formed on the CR39. Energy of the ion beam is measured by scanning a field of vision with an optical microscope, and counting the scars thus formed.

For example, Patent Document 1 (Tokukai, No. 2003-139743; published May 14, 2003) discloses a laser measurement device provided in a time-of-flight mass spectrometer.

However, conventional ion beam detection by use of the solid state track detector CR39 has a problem that a long time is required to detect the ion beam.

More specifically, in order to detect an ion beam by the solid-state track detector CR39, it is required to take out the CR39 from a vacuum chamber after carrying out irradiation of the ion beam. Then it is necessary to carry out an etching process to the CR39 as a preliminary process. Furthermore, measurement of the ion beam is carried out manually, with the use of an optical microscope. Therefore, a problem occurs that it takes a long time from the irradiation of the ion beam to start the measurement of the ion beam.

Particularly, with an ion beam generation device which generates an ion beam by irradiating high intensity laser to a material, it is necessary to adjust energy of the ion beam thereby optimizing a parameter online (in real time). If the conventional solid state track detector CR39 is applied to such ion beam generation device, the long time required for the measurement of the ion beam becomes a large obstacle for the optimization of the parameter.

### DISCLOSURE OF INVENTION

The present invention is made in view of the problems, and an object thereof is to provide an ion beam detector capable of (i) immediately determining energy of an ion beam generated, and (ii) measuring the ion beam in real time while carrying out laser irradiation.

In order to attain the object, an ion beam detector according to the present invention is an ion beam detector configured to detect an ion beam generated from an ion source, comprising: a light conversion section configured to transmit X-rays mixed in with the ion beam and to convert the ion beam to light; a light detection section configured to detect, as an electric signal, the light converted from the ion beam by the light converting section; a time-of-flight measurement section configured to measure a time of flight of the ion beam to reach the light conversion section; an electron removal section provided in an upstream of the light conversion section from which the ion beam comes to the light conversion section, and configured to remove electrons mixed in with the ion beam; a light shielding section provided in the upstream of the light conversion section from which the ion beam comes to the light conversion section, and configured to shield light mixed in with the ion beam; and a curved section provided between the light conversion section and the light detection section, and curved with respect to an optical axis of the ion beam incident on the light conversion section.

The ion beam detector of the present invention includes (i) a light conversion section which transmits X-rays mixed in with an ion beam and converts the ion beam to light, (ii) a light detection section which detects, as an electric signal, the light converted from the ion beam by the light conversion section, and (iii) a time-of-flight measurement section which measures a time of flight for the ion beam to reach the light conversion section.

Measurement of energy of an ion beam is carried out by the ion beam detector based on a time of flight of the ion beam thus measured at the time-of-flight measurement section. The time of flight is determined in an instant. Thus, the energy of the ion beam to be generated is immediately determined, thereby measurement of the ion beam in real time while carrying out laser irradiation is possible.

In an environment in which high intensity laser is irradiated to a material so as to generate an ion beam of high energy (not less than order of 100 keV), light, X-rays, and electrons are mixed in with the ion beam.

With the arrangement, (i) an electron removal section which removes electrons mixed in with the ion beam, and (ii) a light shielding section which shields light mixed in with the ion beam, are provided in the upstream of the light conversion section from which the ion beam comes to the light conversion section. This enables to remove electrons mixed in with the ion beam and to suppress light mixed in with the ion beam, before the ion beam generated at the ion source reaches to the light conversion section. As a result, it is possible to suppress generation of signals caused by the light or electrons, and reduce a background. As a result, a resolution of a signal of the light or electrons, and a signal of the light derived from the ion beam is improved in the detection performed by the light detecting section.

Furthermore, the light conversion section has a curved section in which X-rays mixed in with the ion beam are transmitted, provided between the light conversion section and the light detection section, curved with respect to an optical axis of the ion beam incident on the light conversion section. This prevents the X-rays to reach to the light detection section, and suppresses a signal caused by the X-rays to be generated. Thereby, the background is reduced. As a result, the resolution of the signal of the X-rays, and the signal of the light derived from the ion beam is improved in the detection performed by the light detecting section. The light conversion section in which “X-rays are transmitted” denotes a light conversion section through which X-rays are transmitted without showing any interactive effect towards the X-rays mixed in with the ion beam. Thus, the “light conversion section” in the present invention may be denoted as “a light conversion section which shows no reaction (response) towards X-rays mixed in with the ion beam”.

Furthermore, the ion beam detector according to the present invention includes a time-of-flight measurement section configured to measure a time of flight for the ion beam to reach the light conversion section.

As described above, with the arrangement, it is possible to realize an ion beam detector capable of (i) immediately determining energy of the ion beam generated, and (ii) measuring ion beam in real time while carrying out laser irradiation.

The ion beam detector according to the present invention may be described as an ion beam detector configured to detect an ion beam generated from an ion source, comprising: a light conversion section configured to transmit X-rays mixed in with the ion beam and to convert the ion beam to light; a light detection section configured to detect, as an electric signal, the light converted from the ion beam by the light converting section; a time-of-flight measurement section configured to measure a time of flight for the ion beam to reach the light conversion section; an electron removal section provided in an upstream of the light conversion section from which the ion beam comes to the light conversion section, and configured to remove electrons mixed in with the ion beam; and a light shielding section provided in the upstream of the light conversion section from which the ion beam comes to the light conversion section, and configured to shield light mixed in with the ion beam; and a bent connection section configured to connect the light conversion section and the light detection section, the bent connection section provided bent with respect to an optical axis of an ion beam incident on the light conversion section.

Namely, the “bent connection section” is equivalent to the aforementioned “curved section”. The bent connection section connects the light conversion section and the light detection section, and is bent with respect to an optical axis of an ion beam incident on the light conversion section.

For a fuller understanding of the nature and advantages of the invention, reference should be made to the ensuing detailed description taken in conjunction with the accompanying drawings.

### BRIEF DESCRIPTION OF DRAWINGS

FIG. 1 is a schematic view schematically illustrating one embodiment of an ion detector of the present invention.

FIG. 2 is a schematic view schematically illustrating an electron removal section of an ion beam detector.

FIG. 3(a) is a side view illustrating a light shielding section, a light conversion section, a curved section, and a light detection section in an ion beam detector.

FIG. 3(b) is an enlarged view of the light shielding section, the light conversion section, and the curved section shown in FIG. 3(a).

FIG. 4 is a graph illustrating a result of comparison between ion signals of (i) an ion beam detector having two dipole magnets arranged so that a direction of magnetic fields to be generated faces opposite directions to each other, (ii) an ion beam detector having one dipole magnet, and (iii) an ion beam detector not having a dipole magnet. The graph illustrates relationship of a signal and a time of flight when a neutral density filter 2+4 is used.

FIG. 5 is a graph illustrating a result of comparison between ion signals of (i) an ion beam detector having two dipole magnets arranged so that a direction of magnetic fields to be generated faces opposite directions to each other, (ii) an ion beam detector having one dipole magnet, and (iii) an ion beam detector not having a dipole magnet. The graph illustrates relationship of a signal and a time of flight when a neutral density filter 2+4+8 is used.

FIG. 6 is a graph illustrating a result of comparison between ion signals of (i) an ion beam detector having a band-pass filter and (ii) an ion beam detector not having a band-pass filter. The graph illustrates relationship of a signal and a time of flight when a neutral density filter 2+4 is used, and two dipole magnets are arranged so that a direction of magnetic fields to be generated faces opposite directions to each other.

FIG. 7 is a graph illustrating a result of comparison between (i) an ion beam detector having a band-pass filter and (ii) an ion beam detector not having a band-pass filter. The graph illustrates relationship of a signal and a time of flight when a neutral density filter 2+4+8 is used, and no dipole magnet is provided.

FIG. 8 is a graph illustrating a result of comparison between (i) an ion beam detector having an aluminum evaporated film of a thickness 0.8 μm, and (ii) an ion beam detector not having an aluminum evaporated film. The graph illustrates relationship of a signal and a time of flight, when a neutral density filter 2+4+8+2 and a band-pass filter is provided, and two dipole magnets are arranged so that a direction of magnetic fields to be generated faces opposite directions to each other.

FIG. 9 is a graph illustrating a result of comparison between (i) an ion beam detector having an aluminum evaporated film of a thickness 0.8 μm, and (ii) an ion beam detector having an aluminum evaporated film of a thickness 5 μm. The graph illustrates relationship of a signal and a time of flight, when a neutral density filter 2+4+8+2 and a band-pass filter is provided, and two dipole magnets are arranged so that a direction of magnetic fields to be generated faces opposite directions to each other.

### BEST MODE FOR CARRYING OUT THE INVENTION

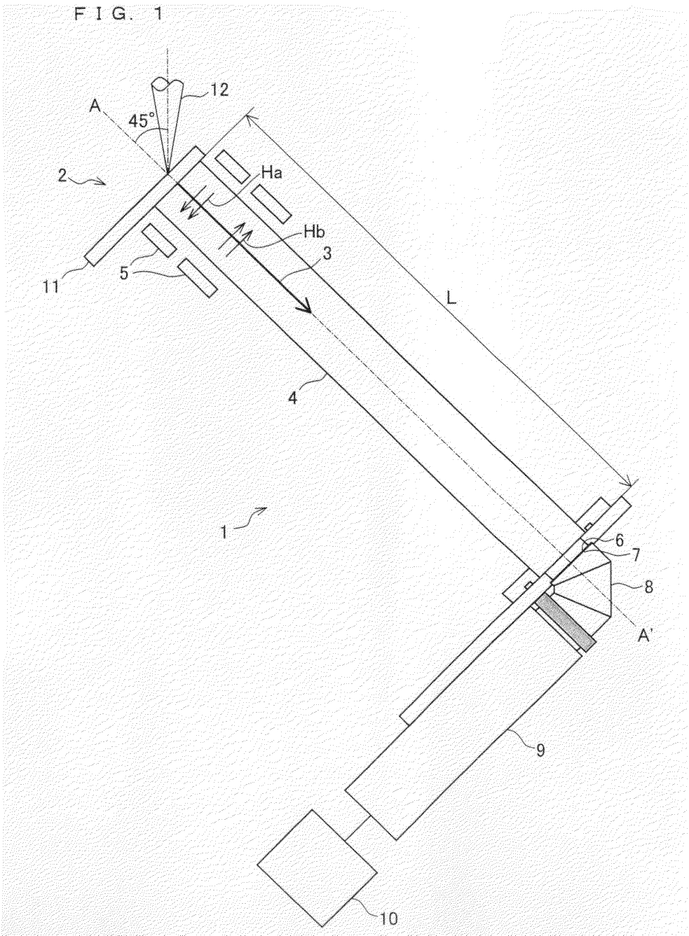

One embodiment of the present invention is described below with reference to FIGS. 1 through 3(a) and 3(b). FIG. 1 is a schematic view schematically illustrating an ion detector of the present embodiment.

An ion beam detector 1 of the present embodiment, as illustrated in FIG. 1, measures energy of ions 3 generated from an ion source 2 based on a time-of-flight method.

The ion beam detector 1 includes a duct 4, an electron removal section 5, a light shielding section 6, a light conversion section 7, a light detection section 9, and a time-of-flight measurement section 10. The ions 3 fly through the duct 4. The electron removal section 5 removes electrons mixed in with the ions 3 generated from the ion source 2. The light shielding section 6 shields light mixed in with the ions 3. The light conversion section 7 converts the ions 3 to light, meanwhile X-rays mixed in with the ions 3 are transmitted through the light conversion section 7. The light detection section 9 receives light converted from the ions 3 by the light conversion section 7 and detects the light as electric signals. In addition, a curved section 8 is provided between the light conversion section 7 and the light detection section 9, curved with respect to an optical axis of the ions 3 (axis AA′ of the duct 4) incident on the light conversion section 7.

The ions 3 are generated at the ion source 2 by irradiating pulse laser light 12 to a target material 11. The ion source 2 applicable to the ion beam detector 1 is not limited to the arrangement shown in FIG. 1, as long as the ion source 2 is capable of generating an ion beam. For example, ion sources such as an ion source in which laser is converged to a jet target or an ion source in which laser is converged to a cluster target are given as examples of the ion source 2 applicable to the ion beam detector 1.

The duct 4 has a length L. The ion beam detector 1 detects the energy of the ions 3 based on a time of flight t required for the ions 3 to fly through the length of L.

The time-of-flight measurement section 10 measures the time of flight t which the ion 3 takes to fly through the length L of the duct 4. Measurement of the time of flight by the time-of-flight measurement section 6 is carried out based on an electric signal of ions detected by the light detection section 9 described later.

The ion beam detector 1 is set so that the time of flight t shortens in time as the energy of the ions 3 increases. The time-of-flight measurement section 10 calculates the energy of the ions 3 by measuring the time of flight t.

More specifically, the time of flight t can be described by the following relational formula, where L is a flight distance of the ions 3 (equivalent to the length of the duct 4).

$$t - \frac{L ( {mc}^{2} + T )}{c \sqrt{{( {mc}^{2} + T )}^{2} - {( {mc}^{2} )}^{2}}} \qquad [ Formula 1 ]$$

where mc² is a rest mass of the ions 3 (when the ions are a proton, mc²=938.2722 MeV), T is kinetic energy (MeV) of the ions 3, and c is light velocity=2.998×10⁸ (m/sec).

Calculation of the kinetic energy of the ions 3 is carried out by substituting the time of flight t measured at the time-of-flight measurement section 10 into the relational formula.

As such, measurement of the energy of the ions 3 by the ion beam detector 1 is carried out based on the time of flight t in which the ions 3 fly through the length L. The time of flight t is immediately determined as soon as the ions 3 reach to the light detecting section 9. Therefore, the energy of the ion beam to be generated is immediately determined, and it is possible to measure the ion beam in real time while carrying out laser irradiation. Furthermore, it is possible to know online, when the ions 3 are generated from the ion source 2 while various parameters are changed, how the energy of the ions 3 are effected by a parameter change.

As described above, in an environment in which high intensity laser is irradiated to a material so as to generate an ion beam of high energy (not less than order of 100 keV), light, X-rays, and electrons are mixed in with the ions 3. Therefore, there is a possibility that a time of flight of light (photon), X-rays, or electrons and a time of flight of ions 3 cannot be distinguishably measured, if the energy of the ions 3 is measured by the time-of-flight method. Namely, the resolution of the signals of the light (photon), X-rays, or electrons detected at the light detection section 9 and the signal of the light derived from the ions 3 becomes poor (background of the signal of the light (photon), X-rays, or electrons increases), and measurement of an accurate time of flight of the ions 3 may not be measured.

The ion beam detector 1 of the present embodiment improves the resolution of the signal of the light (photon), X-rays, or electrons and the signal of the ions 3 (removes the background of the signals of the light, X-rays, or electrons), and includes the electron removal section 5, the light shielding section 6, the light conversion section 7, the curved section 8, and the light detection section 9.

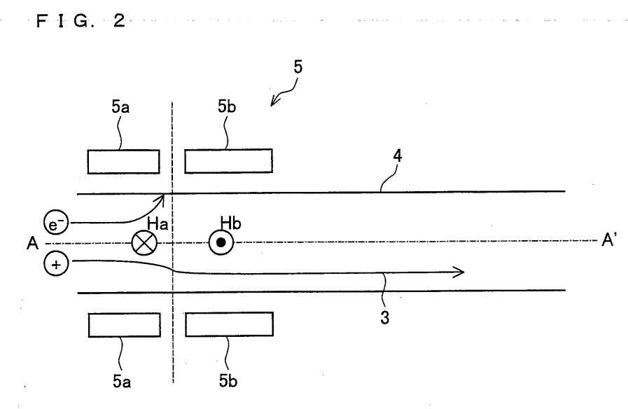

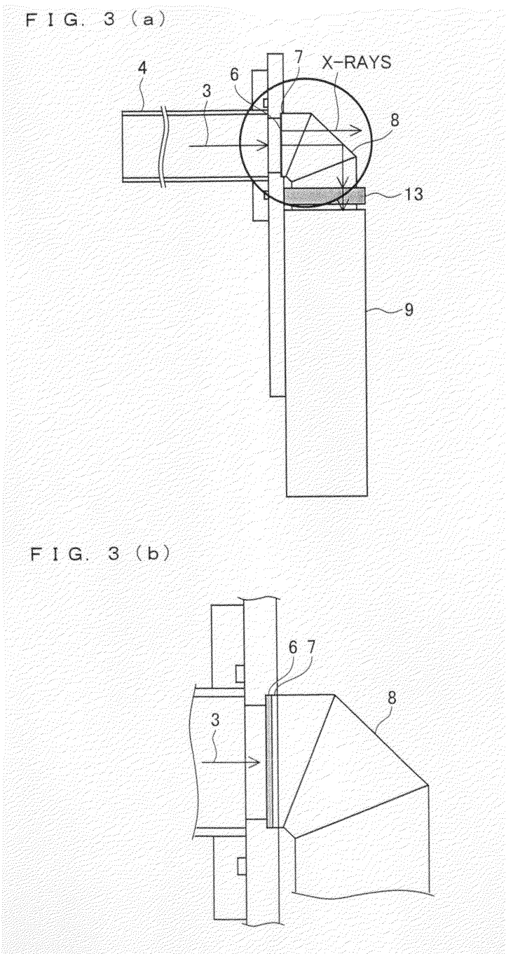

The following description further explains a characteristic arrangement of the ion beam detector 1 of the present embodiment, which is, the electron removal section 5, the light shielding section 6, the light conversion section 7, the curved section 8, and the light detection section 9, with reference to FIG. 2 and FIGS. 3(a) and 3(b). FIG. 2 is a schematic view schematically illustrating the electron removal section 5. FIG. 3(a) is a side view illustrating the light shielding section, the light conversion section, the curved section, and the light detection section in the ion beam detector. FIG. 3(b) is an enlarged view of the light shielding section, the light conversion section, and the curved section.

The following is an explanation of the electron removal section 5. As illustrated in FIG. 2, the electron removal section 5 includes two dipole magnets 5a and 5b. The dipole magnets 5a and 5b are provided on side walls of a duct 4. The dipole magnets 5a and 5b generate magnetic fields Ha and Hb, respectively, each of which is generated perpendicular to an axis AA′ of the duct 4. Furthermore, the dipole magnets 5a and 5b are arranged so that a direction of the magnetic fields Ha and Hb thus generated faces opposite directions to each other.

Due to an effect of the magnetic fields Ha and Hb, electrons e⁻ mixed in with the ions 3 collide with the side walls of the duct 4, thereby not reaching the light shielding section 6. On the other hand, the ions 3 are effected by the magnetic fields Ha and Hb by just a parallel displacement of its track, and still reaches the light shielding section 6. As such, the electrons e⁻ mixed in with the ions 3 are removed in the duct 4. This allows suppression of the generation of the signal caused by the electrons, thereby reducing the background. As a result, it is possible to decrease the proportion of the signals caused by the electrons included mixed in the signals caused by the ions 3.

Strength of the magnetic fields Ha and Hb generated by the dipole magnets 5a and 5b is sufficient as long as the electrons e⁻ are caused to collide to the side walls of the duct 4 whereas the ions 3 are not caused to collide to the side walls of the duct 4. The strength of the magnetic fields Ha and Hb may be set as appropriate according to a type of the ions 3, or energy of the electrons e⁻ mixed in with the ions 3. For example, when the strength of the magnetic fields Ha and Hb is set as 300 G, electrons not more than 2 MeV collide with the side walls of the duct 4. On the other hand, the ions (protons) of 100 keV are effected by just a parallel displacement of its track by 2 mm.

In FIG. 2, the electron removal section has the two dipole magnets arranged so that the magnetic fields Ha and Hb to be generated face opposite directions to each other. However, the arrangement of the electron removal section in the present invention is not particularly limited, provided that the arrangement is capable of removing the electrons mixed in with the ions. For example, the electron removal section may have three or more dipole magnets provided, or may have just one dipole magnet provided. Furthermore, the electron removal section is not limited to an arrangement which removes electrons by generating a magnetic field, and may be arranged such that electrons are removed by generating an electric field.

The following description explains the light shielding section 6, the light conversion section 7, the curved section 8, and the light detection section 9. As illustrated in FIGS. 3(a) and 3(b), the ion beam detector 1 receives, at the light detection section 9, the light converted from the ions 3 by the light conversion section 7.

The light shielding section 6 is provided on that surface of the light conversion section 7 on which the ions 3 are received. The light shielding section 6 shields light mixed in with the ions 3 but allows the ions 3 to pass therethrough. By shielding the light mixed in with the ions 3 by the light shielding section 3, generation of signals caused by the light is suppressed, whereby the background is reduced. As a result, the resolution of the signal of the light and the signal of the ions 3 is improved in the detection performed by the light detection section 9. Note that the wording “shields light” indicates suppression of light transmission.

A member constructing the light shielding section 6 is not particularly limited as long as the member shields light but allows the ions 3 to transmit through the member. For example, the member may be a reflection film which reflects the light towards the ion source 2, while transmitting the ions 3. If a reflection film is used as the member constructing the light shielding section 6, it is preferable to use a light mass metal film (having a small atom number (z) in the periodic table), which is hardly oxidizable. This is because a metal film formed by a metal having a small atom number in the periodic table readily transmits the ions 3. A metal film particularly favorable for the reflection film is, for example, an aluminum (Al) evaporating film. When the aluminum evaporating film is used as the member constructing the light shielding section 6, its film thickness can be set with respect to the energy of the ions 3 generated at the ion source 2. For example, when the ions 3 has an energy of not less than order of 100 keV, the film thickness of the aluminum evaporating film is set to be approximately 2 μm. When the film thickness of the aluminum evaporating film is approximately 2 μm, the ions 3 not more than 220 keV cannot be transmitted through the aluminum evaporating film but remains in the aluminum evaporating film.

In the ion beam detector 1, the ions 3 after the light shielding by the light shielding section 6 are incident on the light conversion section 7. The light conversion section 7 is not particularly limited, as long as the light conversion section 7 has a function which converts the incident ions 3 to light, and is capable of transmitting this light through the light conversion section 7. Particularly, a scintillator is preferable as a member which constructs the light conversion section 7.

The scintillator is a material which generates light when a particle is incident on the scintillator. When a charged particle is incident on the scintillator, electrical attraction and repulsion occur between the charged particle and electrons inside the scintillator. The electrons become excited effected by this attraction and repulsion, and thereby light is emitted.

Of various scintillators, a plastic scintillator is preferable as the member constructing the light conversion section 7. The plastic scintillator has a fast response speed, therefore is advantageous that accuracy in time-of-flight measurement is improved. In addition, since the scintillator is made of plastic, the scintillator is easily processed, and can be made into a desired shape from a view of space and requests related to an environment.

The plastic scintillator emits light to X-rays mixed in with the ions 3, not just the ions 3. Therefore, the light conversion section 7 is preferably arranged so that the X-rays mixed in with the ions 3 are transmitted through the light conversion section 7. When the plastic scintillator is used as the member constructing the light conversion section 7, its thickness may be set as appropriate, depending on sensitivity (luminescence) of the X-rays, or the energy of the ions 3 which are to be detected. More specifically, the thickness of the plastic scintillator set as 0.2 mm allows the X-rays mixed in with the ions 3 to be transmitted therethrough thereby decreasing the sensitivity of the X-rays. Meanwhile, the thickness of the plastic scintillator set as 0.2 mm allows the ions 3 (protons) up to 2 MeV to stay inside the plastic scintillator. The light conversion section 7 “in which X-rays are transmitted” denotes a light conversion section showing no interaction towards X-rays mixed in with the ion beam, when the X-rays are transmitted through the light conversion section 7. Thus, the light conversion section 7 may also be described as “a light conversion section showing no reaction with (action on) the X-rays mixed in with the ion beam”.

The curved section 8 is provided to prevent the X-rays transmitted through the light conversion section 7 to reach to the light detection section 9. That is to say, in the ion beam detector 1, the curved section 8 is provided with a curve with respect to an optical axis (axis AA′ of the duct 4) of the ions 3 incident on the light conversion section 7. The curved section 8 causes the X-rays transmitted through the light conversion section 7 to transmit through the curved section 8, whereas the ions 3 are reflected on the other hand. Thereby, just the ions 3 reach the light detection section 9.

Thus, it is possible to prevent the X-rays mixed in with the ions 3 to reach the light detection section 9. This suppresses generation of signals caused by the X-rays, thereby reducing the background. As a result, the resolution for the signals of the X-ray and the signals of the ions 3 is improved in the detection performed by the light detection section 9.

A member used to construct the curved section 8 is not particularly limited, as long as light is reflected thereby, and X-rays are transmitted therethrough. For example, acrylic plastic may be used as a member constructing the curved section 8.

In the description, “curved” indicates “bent”. Thus, the “curved section 8” may be described as “a bent connection section connecting the light conversion section 7 and the light detection section 9, bent with respect to the optical axis (axis AA′ of the duct 4) of the ions 3 incident on the light conversion section”. The bent connection section (curved section 8) provides a pathway that connects the light conversion section 7 and the light detection section 9 and that is bent with respect to the optical axis of the ions 3 incident on the light conversion section 7. Because of this, the X-rays transmitted through the light conversion section are transmitted through the bent connection section, whereas the ions 3 are reflected at the bent connection section. As such, the ions 3 reach to the light detection section 9.

The bent connection section (curved section 8) is preferably bent with an angle in a range of 30° to 90° with respect to the optical axis of the ion beam incident on the light conversion section. However, the ion detector of the present invention may include two bent connection sections. For example, the bent connection section may be arranged so that two bent connection sections are bent in opposite directions to each other, and that the light detection section 9 is provided parallel to the axis AA′ however, not on the axis AA′.

Furthermore, an absorption member may be provided in the curved section 8, in a progressing direction of the X-rays to be transmitted through the light conversion section 7, so as to absorb the X-rays. This thus prevents the X-rays mixed in with the ions 3 to reach to the light detection section 9 more securely. Lead glass, for example, may be used as the member to absorb the X-rays.

The curved section has a filter 13, as illustrated in FIG. 3(a). The filter 13 is constructed of a neutral density (ND) filter and/or a band-pass filter. The neutral density filter reduces an amount of light, when the light converted from the ions 3 by the light conversion section 7 is in excess. The band-pass filter is capable of transmitting light having an equivalent wavelength range to the light converted from the ions 3 by the light conversion section 7.

The filter 13 is provided to optimize ion detection sensitivity (sensitivity to detect light derived from the ions) of the light detection section 9 described later. Therefore, the arrangement of the filter 13 can be set as appropriate according to the ion detection sensitivity of the light detection section 9. For example, when the ion detection sensitivity of the light detection section 9 is extremely low, and the signal of the ions 3 is weak, the filter 13 is not necessarily provided. A number of the neutral density filter and/or the band-pass filter to be provided can be set as desired according to the ion detection sensitivity of the light detection section 9 and the conversion efficiency of light in the light conversion section 7.

The light detection section 9 detects the ions 3 thus converted to light at the light conversion section 7. More specifically, the light detection section 9 converts the light derived from the ions 3 received at its receiving surface to electric signals, and outputs this signal.

A photo multiplier tube (hereafter referred to as PMT), for example, is suitably used as such light detection section 9. The PMT is a light sensor which, when light is received, (i) converts the light to a photoelectron, (ii) changes the photoelectron to an amplified electric signal, and (iii) outputs the electric signal. The PMT has extremely high sensitivity, and outputs light as an electric signal. Therefore, it is possible to improve the ion detection sensitivity of the ion beam detector 1.

When the PMT is used as the light detection section 9, the filter 13 may be provided as necessary, since the ion detection sensitivity is high.

As the above, the ion beam detector 1 of the present embodiment includes the electron removal section 5 which removes electrons mixed in with the ions 3, the light shielding section 6 which shields light mixed in with the ions 3, and the curved section 8 provided curved with respect to an optical axis (axis AA′ of the duct 4) of the ions 3 incident on the light conversion section 7.

Therefore, when the energy of the ions 3 are measured by the time-of-flight method, it is possible to distinguishably measure the time of flight of the light (photon), X-rays, or electrons and the time of flight of the ions 3. Thus, the resolution of the signals of the light (photon), X-rays, or electrons and the signals of the light derived from ions 3 is improved (background of the signals of the light, X-rays, and electrons can be removed) in the detection performed by the light detecting section 9.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

The following description further explains one embodiment of the present invention by demonstrating Examples by use of the ion beam detector 1, as illustrated in FIG. 1. Of course, the present invention is not limited to the following Examples, and no need to say, various modes are possible for specific parts. As the ion source which generates the ions 3, a 10 TW laser (JLITE-10) of Japan Atomic Energy Agency Kansai Institute was used as means to irradiate pulse laser light 12.

Conditions of the pulse laser light 12 of the 10 TW laser were as follows:
Laser energy: 200 mJ
Pulse width: 250 fs
Contrast: up to 1.0×10⁴
Spot diameter: 11 μm×15 μm
Repetition: 10 Hz (irradiation is 1 Hz)

A Ti thin film having a film thickness of 5 μm was used as a target material 11. The pulse laser light 12 was introduced to an octagonal chamber having a face to face of 1090 mm. The pulse laser light 12 was irradiated to the target material 11 in an incident angle of 45° in a vacuum atmosphere, by use of an OAP having a focus length f of 646 mm. A degree of vacuum while the pulse laser light 12 was irradiated was set as not more than 3×10⁻³ Pa. Furthermore, the target material 11 was of a tape form, and the target material 11 was irradiated while being constantly rolled up. Therefore, the pulse laser light 12 was constantly irradiated to a new surface of the target material 11.

In the present Examples, the length L of the duct 4 was approximately 2 m. A dipole magnet was used as the electron removal section 5. An aluminum evaporating film was used as the member constructing the light shielding section 6. A plastic scintillator having a film thickness of 0.2 mm was used as the member constructing the light conversion section 7. An acrylic resin was used as the member constructing the curved section 8. A PMT (H7195: manufactured by Hamamatsu Photonics K. K.) was used as the member constructing the light detection section 9.

### Example 1

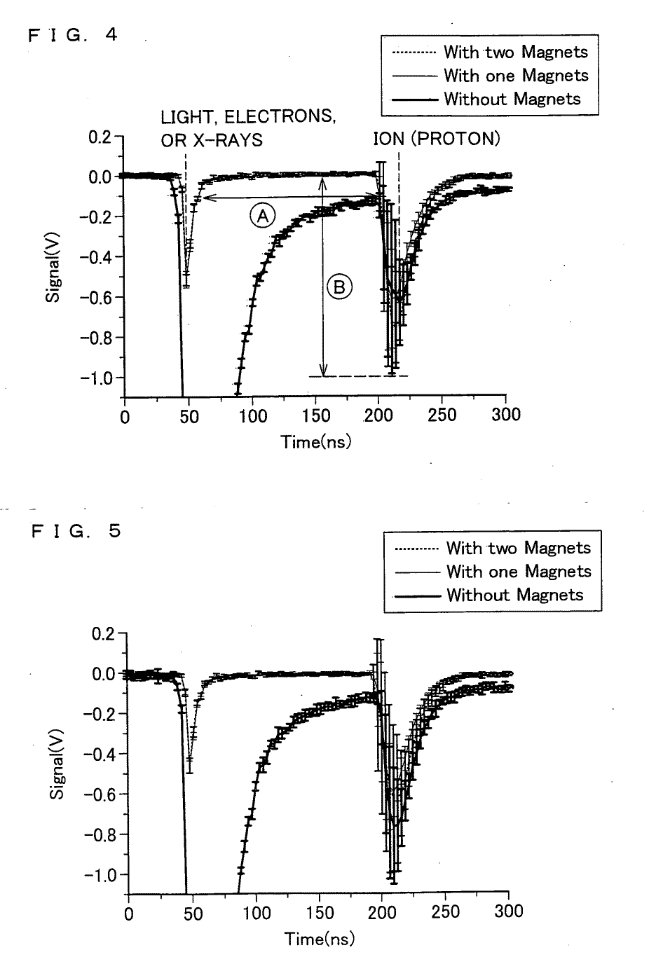

Example 1 studied an effect in ion detection due to a number of dipole magnets provided as the electron removal section 5. More specifically, ion signals were compared, of (i) an ion beam detector having two dipole magnets arranged so as to have a direction of magnetic fields to be generated face opposite directions to each other, (ii) an ion beam detector having one dipole magnet, and (iii) an ion beam detector not having the dipole magnet. A comparison result is as shown in FIGS. 4 and 5. FIG. 4 is a graph illustrating relationship between a time of flight and a signal when a neutral density filter 2+4 was used. FIG. 5 is a graph illustrating relationship between a time of flight and a signal when a neutral density filter 2+4+8 was used.

In the graph shown in FIG. 4, a time corresponding to a peak of a negative signal near 50 ns was a time of flight of light, electrons or X-rays, which were mixed in with the ions. A time corresponding to a peak of a negative signal near 200 ns was a time of flight of the ions. Namely, in FIG. 4, the time of flight of the light, electrons, or the X-rays, which were mixed in with the ions, was approximately 50 ns, and the time of flight of the ions was approximately 200 ns. Energy of the ions was calculated based on a difference between the time of flight of the ions and the time of flight of the light, electrons or the X-rays, which were mixed in the ions (the difference is shown as A in FIG. 4). In the graph shown in FIG. 4, the brief number of ions is assumed based on a height of the peak of the negative signal (the height is shown as B in FIG. 4).

As shown in FIGS. 4 and 5, in the ion beam detector not having the dipole magnet, a drop in the signal near 50 ns was great. As a result, it was impossible to accurately detect the time of flight of the light, electrons, or the X-rays. This was assumingly caused by the strengthening of the signal of the electrons, by not having the electrons mixed in with the ions removed. Namely, the ion beam detector not having the dipole magnet could not distinguishably measure the time of flight of the light (photon), X-rays, or electrons and the time of flight of the ions 3. As a result, resolution of the signals of light (photons), X-rays, or electrons and the signal of the light derived by the ions were poor.

On the other hand, with the ion beam detector which had two dipole magnets arranged so that the direction of the magnetic fields to be generated face opposite directions to each other, and the ion beam detector which has one dipole magnet, it was possible to distinguishably measure the time of flight of the light (photon), X-rays, or electrons and the time of flight of the ions 3.

Therefore, it was clearly shown that the effect on the electrons to be removed differ depending on the number of dipole magnets, from Example 1.

### Example 2

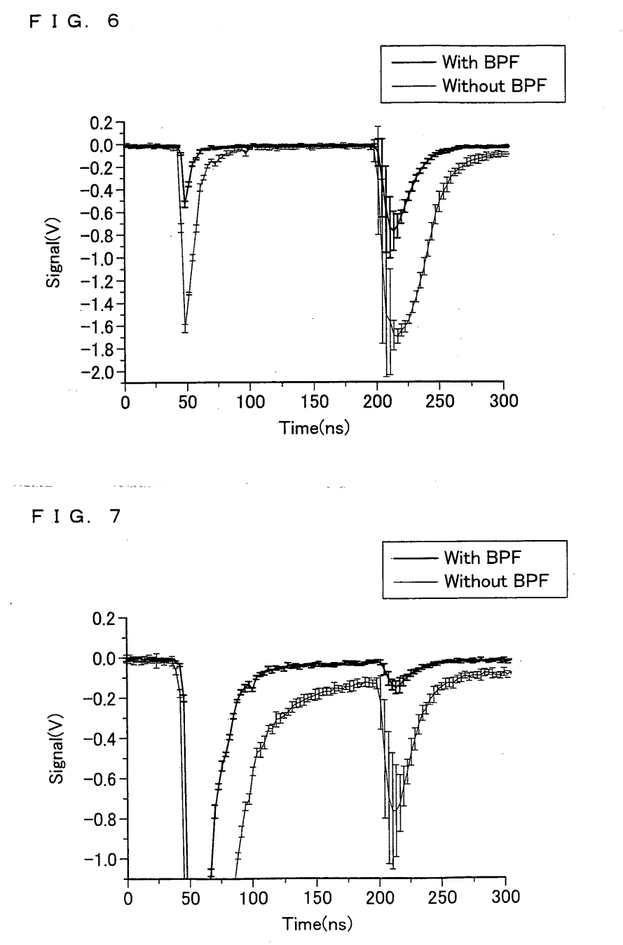

Example 2 studied an effect on ion detection due to a neutral density filter and a band-pass filter (filter 13). More specifically, ion signals were compared, of (i) an ion beam detector having a band-pass filter, and (ii) an ion beam detector not having a band-pass filter. A comparison result is as shown in FIGS. 6 and 7. FIG. 6 is a graph illustrating relationship between a time of flight and a signal when a neutral density filter 2+4 was used and two dipole magnets were arranged so that a direction of magnetic fields to be generated face opposite directions to each other. FIG. 5 is a graph illustrating relationship between a time of flight and a signal when a neutral density filter 2+4+8 was used and no dipole magnet was provided.

As shown in FIGS. 6 and 7, the neutral density filter had different signal densities depending on its reduction of light. Therefore, it was clearly shown that although there was a difference in whether there was a band-pass filter or not, the filter 13 mainly had a function to reduce light.

### Example 3

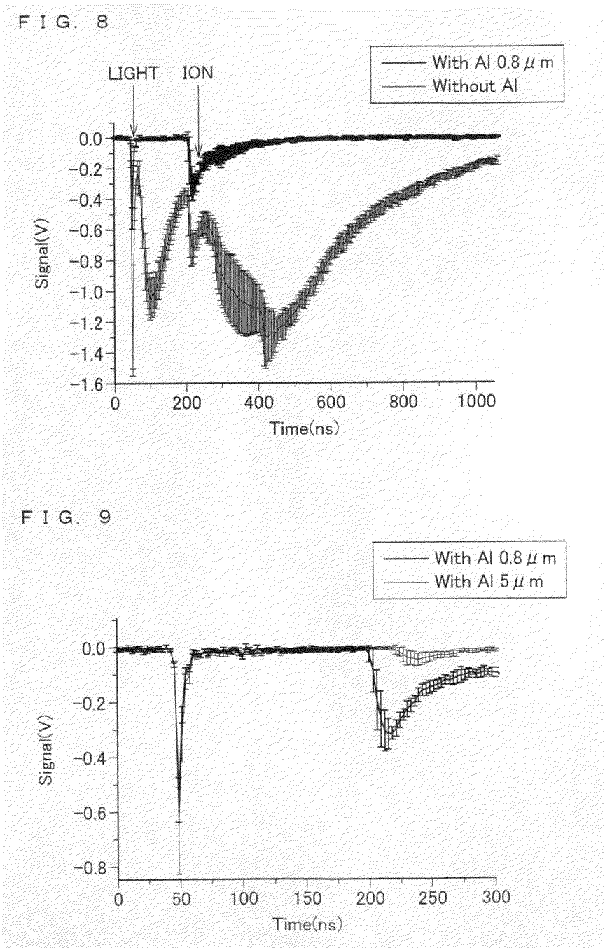

Example 3 studied an effect on ion detection due to an aluminum evaporating film as the light shielding section 6. More specifically, ion signals were compared, of (i) an ion beam detector which included an aluminum evaporating film having a film thickness of 0.8 μm, and (ii) an ion beam detector not including the aluminum evaporating film. A comparison result is as shown in FIG. 8. FIG. 8 is a graph illustrating relationship between a time of flight and a signal when a neutral density filter 2+4+8+2 and a band-pass filter were included, as well as two dipole magnets being arranged so that a direction of magnetic fields to be generated face opposite directions to each other. FIG. 9 is a graph illustrating a comparison result of ion signals of (i) an ion beam detector which included the aluminum evaporating film having a film thickness of 0.8 μm, and (ii) an ion beam detector which included an aluminum evaporating film having a film thickness of 5 μm.

As shown in FIG. 8, the signal of the ion beam detector not including the aluminum evaporating film showed a different state, and was impossible to distinguish the time of flight of the light, electron or X-rays to the time of flight of the ions.

Example 3 carries out the ion detection in an arrangement of the ion beam detector which had a neutral density filter 2+4+8+2 and a band-pass filter as the filter 13, as well as having two dipole magnets arranged so that the direction of the magnetic fields to be generated face opposite directions to each other. Namely, the ion beam detector is arranged so that the electrons and the X-rays mixed in with the ion are removable. Therefore, disturbance in signals noticed with the ion beam detector not having the aluminum evaporating film is assumed to be caused by a strengthening of signals caused by the light mixed in with the ion, which has not been shielded.

On the other hand, it was possible to distinguishably measure the time of flight of the light (photon), X-rays, or electrons and the time of flight of the ions, with the ion beam detector including the aluminum evaporating film having the film thickness of 0.8 μm.

The ion detectors of Example 1 and Example 2, each of which had the aluminum evaporating film, did not show any disturbance in the signals as noticed in the ion beam detector which did not have the aluminum evaporating film (FIGS. 4 through 7). Thus, it is obvious that the effect caused by the light mixed in the ions gave the greatest effect to the ion detection in the ion detector of the present invention. That is to say, if the light mixed in the ions is not shielded, it is not possible to accurately measure the time of flight of the ions. Therefore, in the ion detector of the present embodiment, the aluminum evaporating film (light shielding section) which shields the light mixed in with the ions is an essential feature.

A summary of Examples 1 through 3 are as follows:
(1) Protons were successfully measured in a ToF measurement by use of a plastic scintillator;
(2) In an ion generation experiment by use of JLITE-10 in which a laser parameter was optimized, a measurement of the ions by the time-of-flight method enabled optimization of an extremely large amount of parameters in a short time, compared to an optimization of ions by use of a conventional CR39;
(3) Even with a same irradiation condition, each shot remarkably varied. Variation was great even from a laser intensity point of view. It is assumed that the condition of the target material, or the prepulse intensity is largely related to this; and
(4) A maximum energy (average) of protons obtained by the time-of-flight method matched a result of Thomson Parabola.

As described above, an ion beam detector according to the present invention includes: a light conversion section configured to transmit X-rays mixed in with the ion beam and to convert the ion beam to light; a light detection section configured to detect, as an electric signal, the light converted from the ion beam by the light converting section; a time-of-flight measurement section configured to measure a time of flight of the ion beam to reach the light conversion section; an electron removal section provided in an upstream of the light conversion section from which the ion beam comes to the light conversion section, and configured to remove electrons mixed in with the ion beam; a light shielding section provided in the upstream of the light conversion section from which the ion beam comes to the light conversion section, and configured to shield light mixed in with the ion beam; and a curved section provided between the light conversion section and the light detection section, and curved with respect to an optical axis of the ion beam incident on the light conversion section. The “curved section” may be described as “a bent connection section configured to connecting the light conversion section and the light detection section, bent with respect to an optical axis of an ion beam incident on the light conversion section”.

The curved section (bent connection section) is preferably curved with an angle in a range of 30° to 90° with respect to the optical axis of the ion beam incident on the light conversion section.

Measurement of energy of an ion beam is carried out by the ion beam detector based on a time of flight of the ion beam thus measured at the time-of-flight measurement section. The time of flight is determined in an instant. Thus, the energy of the ion beam to be generated is immediately determined, whereby measurement of the ion beam in real time while carrying out laser irradiation is possible.

In an environment in which high intensity laser is irradiated to a material so as to generate an ion beam of high energy (not less than order of 100 keV), light, X-rays, and electrons are mixed in with the ion beam.

With the arrangement, (i) an electron removal section which removes electrons mixed in with the ion beam, and (ii) a light shielding section which shields light mixed in with the ion beam, are provided in the upstream of the light conversion section from which the ion beam comes to the light conversion section. This thus enables removal of electrons mixed in with the ion beam and suppression of light mixed in with the ion beam, before the ion beam generated at the ion source reaches to the light conversion section. As a result, it is possible to suppress generation of signals caused by light or electrons, and reduce a background. As a result, a resolution of a signal of light or electrons, and a signal of the light derived from the ion beam is improved in the detection performed by the light detecting section.

Furthermore, the light conversion section has a curved section that transmits therethrough X-rays mixed in with the ion beam, is provided between the light conversion section and the light detection section, and is curved with respect to an optical axis of the ion beam incident on the light conversion section. This prevents the X-rays to reach to the light detection section, and suppresses a signal caused by the X-rays to be generated. Thereby, background is reduced. As a result, a resolution of a signal of the X-rays, and a signal of the light derived from the ion beam is improved in the detection performed by the light detecting section.

As described above, with the arrangement, it is possible to realize an ion beam detector capable of (i) immediately determining energy of the ion beam generated, and (ii) measuring an ion beam in real time while carrying out laser irradiation.

The ion beam detector of the present invention is preferably arranged such that the electron removing section includes a dipole magnet; and the dipole magnet is provided so that a direction of a magnetic field to be generated is perpendicular to the optical axis of the ion beam.

With the arrangement, a direction of a magnetic field generated due to the dipole magnet is perpendicular to the optical axis of the ion beam. Therefore, a track of the electrons mixed in with the ion beam slides off from a track of the ion beam. As a result, with the arrangement, the electrons mixed in with the ion beam do not reach the light conversion section. Thus, the electrons mixed in with the ion beam are removed before the ion beam generated at the ion source reaches the light conversion section. This suppresses signal generation caused by the electrons, thereby reducing the background.

The ion beam detector according to the present invention is preferably arranged such that the light shielding section is a metal film by which the light mixed in with the ion beam is reflected towards an ion source and which allows the ion beam to transmitted therethrough.

The light mixed in the ion beam is reflected by a metal film towards the ion source. Therefore, it is possible to securely shield the light mixed in with the ion beam.

The ion beam detector according to the present invention is preferably arranged such that the light conversion section is a plastic scintillator.

A plastic scintillator has a fast response speed, therefore is advantageous that accuracy in time-of-flight measurement is improved. In addition, since the scintillator is made of plastic, the scintillator is easily processed, and can be made in a desired shape from a view of space and requests related to an environment.

The ion beam detector according to the present invention is preferably arranged such that the curved section has a neutral density filter configured to reduce the light converted from the ion beam by the light conversion section.

The ion beam detector according to the present invention is preferably arranged such that the curved section has a selective filter configured to selectively transmit the light converted from the ion beam by the light conversion section.

Thus, it is possible to optimize detection sensitivity of the ion beam, for example when an ion beam detection sensitivity is high in the light detection section, by reducing or selectively transmitting light converted from the ion beam by the light conversion section.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

As described above, an ion beam detector of the present invention improves resolution of signals of light (photons), X-rays, or electrons and signals of light derived from ions, in the detection performed by the light detection section. Therefore, the invention is applicable to fields in which ion beams are generated.

1. An ion beam detector configured to detect an ion beam generated from an ion source, comprising:
a light conversion section configured to transmit X-rays mixed in with the ion beam and to convert the ion beam to light;
a light detection section configured to detect, as an electric signal, the light converted from the ion beam by the light converting section;
a time-of-flight measurement section configured to measure a time of flight of the ion beam to reach the light conversion section;
an electron removal section provided in an upstream of the light conversion section from which the ion beam comes to the light conversion section, and configured to remove electrons mixed in with the ion beam;
a light shielding section provided in the upstream of the light conversion section from which the ion beam comes to the light conversion section, and configured to shield light mixed in with the ion beam; and
a curved section provided between the light conversion section and the light detection section, and curved with respect to an optical axis of the ion beam incident on the light conversion section.

2. The ion beam detector as set forth in claim 1, wherein the curved section is curved with an angle in a range of 30° to 90° with respect to the optical axis of the ion beam incident on the light conversion section.

3. The ion beam detector as set forth in claim 1, wherein:
the electron removal section comprises a dipole magnet; and
the dipole magnet is provided so that a direction of a magnetic field to be generated is perpendicular to the optical axis of the ion beam.

4. The ion beam detector as set forth in claim 1, wherein the light shielding section is a metal film by which the light mixed in with the ion beam is reflected towards an ion source, and which allows the ion beam to transmitted therethrough.

5. The ion beam detector as set forth in claim 1, wherein the light conversion section is a plastic scintillator.

6. The ion beam detector as set forth in claim 1, wherein the curved section has a neutral density filter configured to reduce the light converted from the ion beam by the light conversion section.

7. The ion beam detector as set forth in claim 1, wherein the curved section has a selective filter configured to selectively transmit the light converted from the ion beam by the light conversion section.

8. An ion beam detector configured to detect an ion beam generated from an ion source, comprising:
a light conversion section configured to transmit X-rays mixed in with the ion beam and to convert the ion beam to light;
a light detection section configured to detect, as an electric signal, the light converted from the ion beam by the light converting section;
a time-of-flight measurement section configured to measure a time of flight for the ion beam to reach the light conversion section;
an electron removal section provided in an upstream of the light conversion section from which the ion beam comes to the light conversion section, and configured to remove electrons mixed in with the ion beam; and
a light shielding section provided in the upstream of the light conversion section from which the ion beam comes to the light conversion section, and configured to shield light mixed in with the ion beam; and
a bent connection section configured to connect the light conversion section and the light detection section, the bent connection section provided bent with respect to an optical axis of an ion beam incident on the light conversion section.
